(19) United States
(12) Patent Application Publication
(10) Pub. No.: US 2007/0005192 A1
(43) Pub. Date: Jan. 4, 2007

(54) Fast acting distributed power system for transmission and distribution system load using energy storage units

(75) Inventors: Roland Schoettle, American Canyon, CA (US); James W. Detmers, Folsom, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Optimal Licensing Corporation, Freeport (BS)

(21) Appl. No.: 11/454,290

(22) Filed: Jun. 16, 2006

Related U.S. Application Data
(60) Provisional application No. 60/692,062, filed on Jun. 17, 2005.

(51) Int. Cl. G05D 11/00

(52) U.S. Cl. 700/286

(57) ABSTRACT

An electric power load management system and method that uses a multiplicity of remote power supplies in a controlled manner such that the aggregate system has the capacity to offset critical power company peak electric demand periods thereby preventing severe and detrimental power shortages and interruptions.

### CROSS-REFERENCE TO RELATED APPLICATIONS

This application claims priority benefit of U.S. Provisional Patent Application No. 60/692,062 entitled “DISTRIBUTED POWER GENERATION FOR TRANSMISSION AND DISTRIBUTION SYSTEM LOAD USING UNINTERRUPTIBLE POWER SOURCES,” filed Jun. 17, 2005, the disclosure of which is hereby incorporated herein by reference. This application is related to co-pending and commonly assigned U.S. patent application Ser. No. 11/175,970 entitled “SYSTEM AND METHOD FOR MANAGING POWER DISTRIBUTION,” filed Jul. 5, 2005, the disclosure of which is hereby incorporated herein by reference.

### TECHNICAL FIELD

The invention pertains to the field of utility peak demand management for use in reducing blackouts and brownouts and other utility power system risk and for use in providing continuous power, added reliability, and additional reserve capacity margins without the need for costly and environmentally unfriendly additional transmission, distribution, or generation resources.

### BACKGROUND OF THE INVENTION

Electricity is a peculiar commodity, in that it cannot be easily stored and that is generally consumed within a fraction of a second from its production. For these reasons, the cost of electricity is highly dependent on generation, transmission, and distribution system constraints caused by a change in load at time of use.

The electric power industry is handicapped by electric demand load variability, which during critical periods, can cause power consumption peaks that threaten the integrity of the electric generation and transmission systems. These critical conditions can lead to restricted capacity incidents (i.e. brownouts) and/or interruptions (i.e. blackouts).

Frequently when a new generating plant (or other ancillary service device) is added to meet demand, local customers become dependent on the operation of this “must run” system resource. Ancillary service devices are categorized into scheduling devices (capacity, energy), system control and dispatch devices, reactive supply and voltage control devices, energy imbalance devices, operating reserve, regulation, and frequency response devices. Moreover, the presence of the system resource often generates unwanted distortions outside of the local area that can have dramatic congestion effects on other parts of the larger system. In turn, this can create a domino effect, repeatedly requiring more localized “must run” generators and other mitigating system devices to meet peak demand. Having any part of the system operating under Must Run conditions can promote further market price and emission manipulation.

While the traditional response to such threats has been the building of more generating, transmission, and distribution system capacity, such actions have become very costly leading to delayed implementation in search of more immediate, economical, and environmentally friendly solutions. Currently the process to achieve greater load leveling (peak reduction) includes variable rate incentives and disincentives designed to influence consumers power consumption. Although less than successful, these efforts are designed to avoid peaks and fill low points of consumption. The process has also been augmented by the practice of building small generating units to serve base load growth and as peaking plants.

Similarly, a separate independent power producing industry has developed adding to the mix of supply-side generation and ancillary energy services. The number of elements contributing to a power service network has grown complex and has brought with it its own set of power management problems. While the quest for more power is evident, the issue of greatest importance is the means to manage many smaller system that will come on line in the near future. An example of this trend is the emphasis on renewable but often sporadic sources such as solar and wind farms that will further add to the complex process of energy source and energy delivery management.

A typical commercially available uninterruptible power supply 10 is shown in FIG. 1. The UPS device 12 connects to the grid 11 and to the load 13 in an in-line fashion. Many UPS systems use replaceable, rechargeable internal batteries from which to provide the load with an amount of uninterrupted electric power in the event of a grid power source disturbance or interruption. For battery-type UPSs, the load would experience a power interruption if the grid power source does not recover before battery power is exhausted. The majority of UPS systems also include a data port 14 that can be configured with software to shutdown the load in an orderly fashion. During a grid disturbance or interruption, the shutdown instruction from the UPS to the load is in response to a battery that can no longer support the attached load. The time from fully charged to shutdown instruction is the maximum “runtime” of the UPS system.

The “runtime” of a UPS is dependant on battery capacity (or fuel supply for non-battery systems) and the energy consumption rate of the attached load. For battery-type UPS systems, the UPS system includes a battery charger to return the internal battery to a charged state once grid power is restored. Fully discharged batteries typically require 2-6 hours to reach 90% capacity. The runtime is a deciding factor in the purchasing decision and is therefore critical to determine correctly throughout the life of the UPS system. For battery-type UPS systems, batteries are the major source of runtime degradation and are therefore designed to be easily replaceable. UPS batteries typically last 4-6 years under normal conditions. Battery level indicators found on many commercial battery-type UPS systems are known to be exceptionally inaccurate, for example showing hours of available runtime when in fact only minutes actually exist.

### BRIEF SUMMARY OF THE INVENTION

The present invention is directed to systems and methods that include a power management system designed to offset load imbalances over a wide area of the electric power network by remotely controlling power managed sites via a wide area communications network. Embodiments of the invention energize a multiplicity of smaller installed remote electric power supplies to support a given electric load during peak electrical demands or requests for select ancillary services.

Embodiments of this invention are capable of managing many diverse sources of available electric energy. This is accomplished through a matrix of monitoring and special high speed computational analysis to control remote UPS power supplies. Thus, embodiments of the invention control a vast array of smaller power supply units to reduce the hazards of load imbalances without installing additional generators. This leads to a more efficient and reliably performing electric service system that also uses fewer expensive “Must Run” devices.

Embodiments of the invention may involve large scale power grids, as well as microgrids, such as campuses, and also to individual homes and buildings. For example, a home with no connection to the grid but that has wind or solar (photovoltaic) generators to power the house could use embodiments of the invention to supply power to critical systems (e.g. computers, security, refrigeration, etc.) when there is an abnormal drop in wind or sunlight. In this context the “grid” is the home wiring network.

Embodiments of the invention exploit the energy stored within uninterruptible power supply (UPS) systems that currently are being used to insure continuous operation of critical electric equipment for the benefit of offsetting peak power problems on the grid. Such power supplies insure availability and are cost justified for their value in maintaining the flow of electric power during line interruptions. However, such systems are seldom function for the purpose of supplying electric power except during rare line power failures essentially wasting a valuable storage resource that may be applied to important load leveling functions on a more regular basis. Embodiments of the invention exploit this potential by controlling this storage in its various forms.

Embodiments of the invention involve an integrated power management and UPS (Uninterruptible Power Supply) system. The integrated power management and UPS system serves two functions. The first is the standard UPS function, namely to provide power to an attached load when AC grid power is unavailable. The second provides load and local power supply management functions for grid offset with remote control. Grid offset is where a UPS device is used to off-load or lessen the power normally provided by the grid, whether supplied from local or from distant sources, thereby providing grid offset support without device load power supply interruption. In other words, grid offset is where the UPS is used to run the local load (and thereby reduce demand on the grid) and/or provide power to the grid. Note that capacity is typically expressed in VA or Volts times Amps. The capacity available for grid offset cannot be greater than the available runtime of the UPS, as determined by the size of the battery and/or amount of fuel of the UPS. Grid offset is possible because the power to the device load is supported by the combination of grid AC power and local power supplied from the local UPS energy source. In addition, the load and power supply management is fully controlled for when and how much grid AC power is used to replenish the local UPS energy power source when batteries are the power source to avoid creating a new load spike as the UPS batteries recharge.

Embodiments of the invention have grid offset be less than available runtime of the UPS, such that there will always be some power available in the UPS system. If grid offset support equals runtime reserve then there is no UPS capacity that can be made available for contingency conditions, e.g. an actual power outage. This is problematic because the original intent of the UPS system was for contingency purposes. Thus, there may be no available UPS battery power immediately after the execution of a grid offset for unexpected grid interruptions. Consequently, embodiments of the invention leave contingency reserve power available in the UPS, such that Grid Offset Runtime minus Contingency Reserve Time equals Grid Offset Support Time, or (RT-CRT=GOST). Embodiments of the invention allow either a grid manager and/or a UPS end-user to have the ability to choose how much Contingency Reserve capacity to allocate for emergencies.

Embodiments of the invention also allow for programmable trade-offs between the amount of Grid Offset versus the Runtime, the programmable amount of Contingency Reserve, and the programmable trade-off between Grid Offset, Runtime, and Contingency Reserve in any combination.

Embodiments of the invention allow for the retrofitting of existing systems to convert installed UPS systems to a power management and UPS system.

It is a feature of embodiments of the invention to respond immediately.

It is a feature of embodiments of the invention to accurately and dynamically measure UPS load and Reserve times.

It is another feature of embodiments of the invention to provide an accurate and reliable method to determine actual runtimes without access to the internals of the UPS, as opposed to typically inaccurate indicators that are integrated into the UPS.

It is a further feature of embodiments of the invention to avoid detrimental demand peaks that would otherwise lead to brown-outs or interruptions.

It is a still further feature of embodiments of the invention to reduce reliance on higher cost “Must Run” generators.

It is a still further feature of embodiments of the invention to provide reliable ancillary services options that are of lower cost.

It is a still further feature of embodiments of the invention to allow local uninterruptible power supply devices to meet their intended operating requirements.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 depicts a prior art uninterruptible power supply;

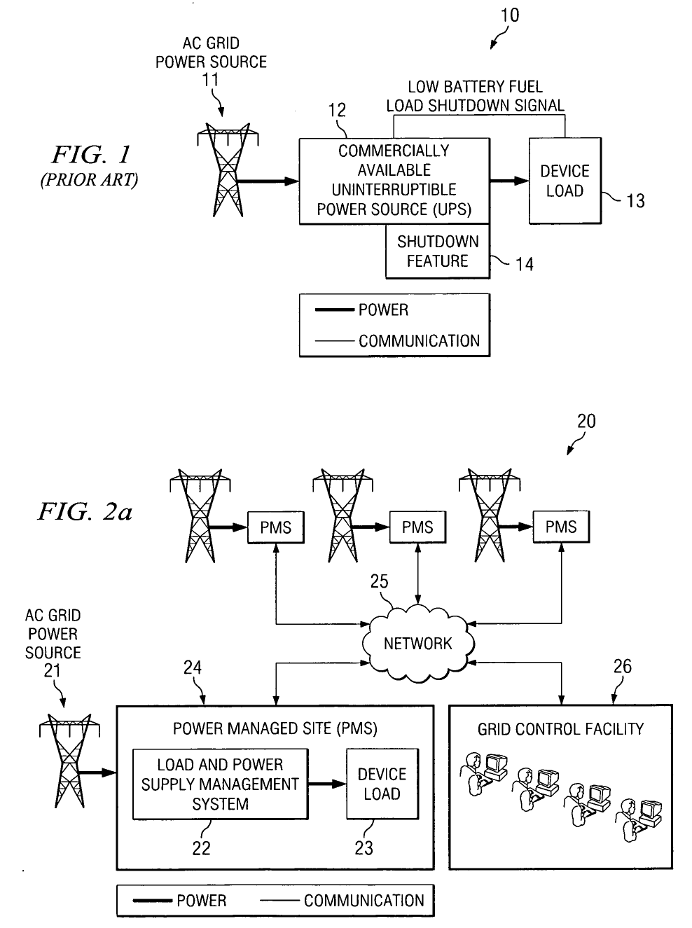

FIGS. 2A-2C depict examples of arrangements of embodiments of the invention;

FIG. 3 depicts an example of an arrangement of an embodiment of the invention that includes an on/off switch;

FIG. 4 depicts an example of an arrangement of an embodiment of the invention that includes variable switch;

FIG. 5 depicts an example of an arrangement of an embodiment of the invention that includes a parallel bypass subsystem;

FIG. 6 depicts an example of an arrangement of an embodiment of the invention that includes programmable battery charger;

FIG. 7 depicts an example of an arrangement of an embodiment of the invention that includes carry-over power unit; and

FIG. 8 depicts an example of an arrangement of an embodiment of the invention that includes aspects of FIGS. 3-7.

### DETAILED DESCRIPTION OF THE INVENTION

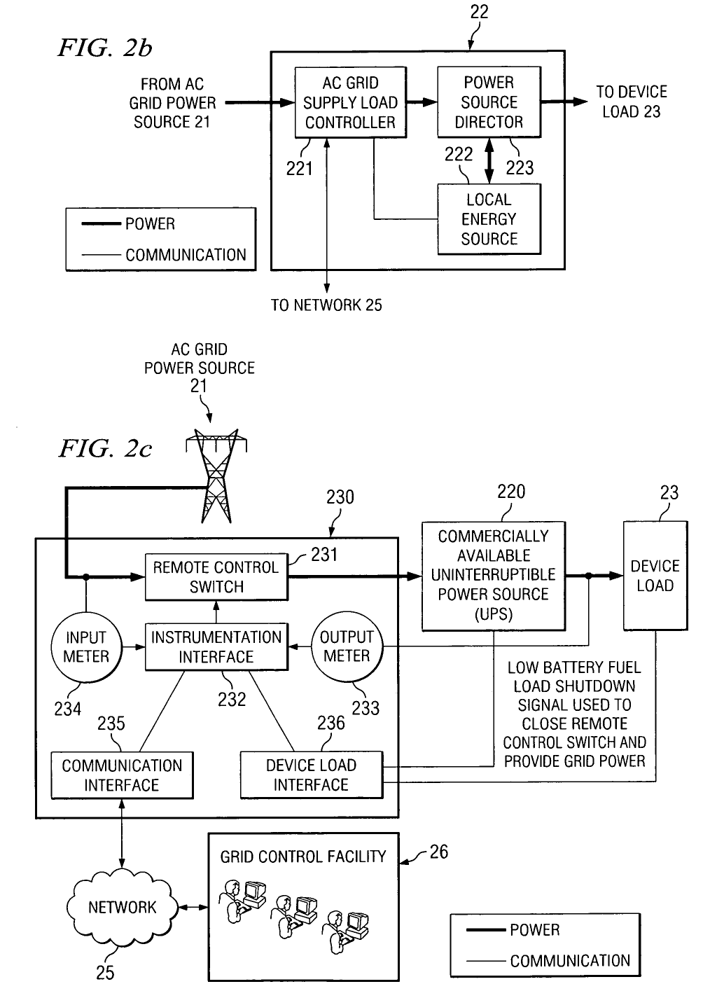

FIG. 2A depicts an arrangement of an embodiment of the invention. In FIG. 2A, a plurality of Power Managed Sites (PMS) 24 are connected to AC grid power sources 21. Note that each source 21 may comprise a different grid, a different portion of a grid, the same portion of the grid, or combinations thereof. Each PMS 24 is also connected to a grid control facility 26 through network 25, which may be a wide area network. Each PMS 24 may represent a home, school, business, other power consumer, or a component at one of those locations. Note that one location may have more than one component. Each PMS 24 includes a load management and power supply management system 22 and a device load 23. Management system tracks the demands of the load 23 and the amount of UPS power available at PMS 24, and sends this information to the grid control facility 26 on a period basis or continuous basis. The UPS Management System 20 is used to reduce AC Power requirements from the utility to the loads 23. This is accomplished by sending load reduction requests or order from the utility or grid control center 26. In one embodiment, the PMS 24 may decide whether to comply with the request based upon the state of the local power source and/or the criteria of the local user. In another embodiment, the PMS complies with the orders issued by the facility 26. In any event, the PMS 24 may then re-engage the connection with the gird when the contingency reserve of the local power source has been reached. 10036] FIG. 2B depicts an embodiment of the management system 22 of FIG. 2A. System 22 includes AC Grid Supply Load controller 221, which switches the connection with the grid power source on/off. The controller 221 also monitors the state of the grid. Power Source Director 223 arbitrates the power being delivered to the load from the grid and the local energy source 222. When the grid becomes deficient from either a black-out or brown-out, the director 223 routes power from local source 222 to the load. The local source 222 may be a battery or a power generator. If the source 222 is a battery, the director may route power from the grid to the source 222 to recharge the battery.

FIG. 2C depicts an embodiment of the inventor for a PMS that is fitted to an existing system. Power Management System 230 is coupled between the grid source 21 and an existing UPS 220. System 230 includes remote control switch 231 that cuts power to the UPS 220 thereby simulating a grid interruption to the UPS. The UPS 220 responds normally by automatically switching to backup power from batteries or generator. Backup power from batteries or a generator would be based on Grid Offset commands issued remotely by an authorized utility, namely facility 26 or in response to internal UPS requests to engage the AC Grid Power Source when UPS Runtime becomes low. The internal UPS request to engage the AC Power Source would be derived from “trapping” the UPS command for an orderly shutdown of the load from the UPS data port. The shutdown signal would only be delayed momentarily, time sufficient to re-engage the AC Power Source and reverse the shutdown command. In the event the AC Power Source is unavailable, the Delay Device defaults to a normally closed position and the shutdown proceeds normally. In the event a UPS data port is unavailable, a delivery output detector or output meter 233 can be used in concert with an electricity source detector or input meter 234 and embedded software programs to accurately determine when the AC Power Source is re-engaged. Instrumentation interface 232 receives data from meters 233 and 234 and provides the data to the embedded software. Similarly, communication interface 235 connects the PMS 230 (including the embedded software) to the network 25. Device load interface 236 receives data regarding the state of the UPS 220 and the load 23 and provides the data to the embedded software. The embedded software may reside in interface 231 or on another component (not shown).

The embodiments of FIGS. 2A-2C may be controlled through a special interactive communication network 25 linked to the PMS devices 24 and 230. These devices cause any given un-interruptible power source device to promptly come on-and off line as directed. These systems are capable of precisely targeting and displacing electric load peaks in proportion to the number and power magnitude of the remote controlled power supplies under its control.

Embodiments of the invention may monitor the energy storage unit or UPS, as well as the load. A component of the PMS may determine the maximum load attached that is attached to the UPS, which is known as the latched high limit. A component may also determine the minimum load attached to the UPS, which is known as the latched low limit. The maximum and minimum may be recorded and provided to the PMS end-user, via a display or a printer. A component may also correlate the UPS load with a UPS output to determine non steady-state or self-powered run times. In other words, the component may determine the available operating time in which the UPS can serve the load connected to it without adequate incoming electrical supply from the grid.

Another embodiment of the invention provides the PMS with an override switch, that allows the PMS end-user to manually connect a previously disconnected ESU to avoid the shutdown of the load. The override switch may also be remotely activated by the user or by the grid control facility. A component may track the number and time of overrides. The grid control facility may also track the number and times of overrides. The override data may be displayed to a user. The historical data associated with overrides may be used to predict the probability (stochastic analysis) of how many users will override and to what function or service the override will apply. This is useful for energy service providers and can be tied to other historical data, such as date, weather, humidity, etc., to further increase analysis and risk-avoidance reliability.

Embodiments may allow for aggregating the quantity of electrical power available within numerous UPSs. In other words, the available time in which numerous UPSs can serve load connected to them without incoming electrical supply from the grid may be aggregated. To do this a component may track and display the quantity of electrical power available within numerous UPSs.

Embodiments of the invention may allow for determining the power quality of the power grid. Components located at the grid control facility may track and display local grid power quality (e.g. sags, blips, voltage problems, frequency problems, simple waveform analysis, etc.) for the purpose of correlating service/process/equipment downtime with specific power quality events.

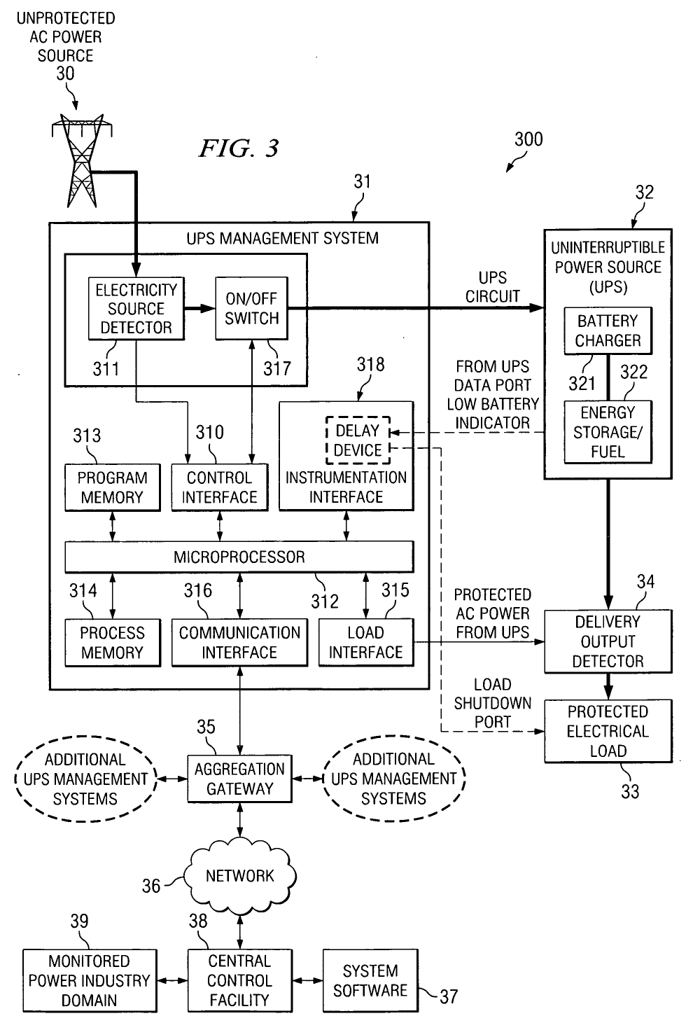

FIG. 3 depicts an arrangement 300 of another embodiment of the invention. The system 31 of FIG. 3 uses an On/Off Switch 317 to disconnect the AC Power Source 30 and simulate a localized blackout condition. In this embodiment, the load 33 is supported only by the energy storage 322 capacity in the UPS 32 or by AC source 30. This embodiment provides only for two (2) operating conditions, namely 100% Grid Offset or 0% Grid Offset. Note that the UPS batteries are slow to charge, and thus there is some added power consumption required to charge the batteries when AC Power is restored. This added consumption when aggregated with other system of this type can exacerbate peak grid electricity demand. Also, because of the On/Off requirement for system 31, Contingency Reserves are exceptionally difficult to perform.

The system 31 of this invention that functions in the interpretation, detection, and control of peak electrical demands in concert with information and direction from the Central Control Facility 38. It directs the alternative source of power 32 to come on line to service an electric load 33 as needed and insures that adequate Energy Storage 322 is available for a predetermined time.

The UPS 32 is a system that incorporates an alternative source of power such as a storage battery or fuel supported electric generator to support an electrical load. It detects when line power has become unavailable and automatically provides the alternate source of electric power to come on-line to support an electrical load in the event of a line power failure. It causes the source of backup power to be connected to the electrical load. Similarly it detects when power is restored.

The Protected Electrical Load 33 is the electrical load or loads being serviced by electric power system and protected from interrupted power by the UPS 32.

The Network Connection 36 comprises any suitable long distance electronic communications network capable of transferring two-way information among a variety of devices.

The On/Off Power Interrupter 317 is capable of causing the line power supporting an uninterruptible power supply unit to be turned off and on. This is usually accomplished at zero crossing of the sine wave with an electromechanical switch or relays type contactor of the double-pole-double-throw type where two side of a single phase circuit are switched at the same time. It is used in this embodiment to simulate a power interruption condition or to restore power as required. It causes the UPS 32 to come on and off line in support of its load. In failure, it automatically turns On (normally closed).

The Energy Storage 322 is any source of energy storage that may be converted into electric energy as an alternative source of power relative to the line power derived from the Grid. This includes but is not limited to a rechargeable battery storage, fuel cell with its fuel source, spinning flywheel, operating flow battery, or engine-generator using a hydrocarbon fuel source where the energy is stored in the chemical nature of the fuel.

The Battery Charger 321, for battery-type UPS systems, is a component of the UPS 32 and recharges the battery-type energy storage 322.

The Instrumentation Interface 318 is a component of the UPS Management System 31 and allows operational variables, external to the system, to be quantified and converted into digital information for processing. This component may be capable of a large array of interpretive data both in the receiving and sending mode. This component also may accept “shutdown” information from the UPS 32 Data Port in order to for the UPS Management System to re-engage the AC Power Source to supply electricity to the Electrical Load 33 and to recharge the UPS batteries 322. The shutdown information normally destined for the load is delayed momentarily to allow On/Off Switch 317 to close, engaging AC line power. Engaging AC line power resets the UPS 32 back to normal operating condition, removes the shutdown command, and recharges the UPS battery 322. In the event of AC Power Source failure, it reverts to being a normally closed circuit and automatically sends any and all shutdown commands without delay. It receives its direction from the Microprocessor 312.

The Communications Interface 316 is a two way digital communications component that converts processed information to be compatible with the Microprocessor 312 and is also compatible with the communication protocols of the long distance communication functions of the Network Connection 36.

The Control Interface 310 is the component that accepts electricity information from the Electricity Source Detector 311 and energizes the switching device 317 as the mechanism for simulating a power interruption in order to influence the UPS 32 to use its Storage 322 in place of all line power. It receives its direction from the Microprocessor 312.

The Electricity Source Detector 311 is the component that determines and digitizes various electricity-related measurements, including but not limited to voltage, current, power, frequency, impedance, and run-times. It is attached to the input-side of the UPS Management System 31 but does not effect the normal operation of the UPS 32 or Load 33.

The Microprocessor 312 is a digital micro computer capable of processing information and decision making depending on the instructions in its programs stored in memory 313. It serves the critical defining storage usage role in this system.

The Program Memory 313 contains the program instructions for the Microprocessor 312 as part of the operations of the UPS Management System 31. This memory may be non-volatile but can be changed by instructional commands from the Central Control 38 or other command source, e.g. the system customer.

The Process Memory 314 is a memory that may be dynamic and holds temporary information as part of the computation process functions of the Microprocessor 312.

The Load Interface 315 is the component that accepts electricity information from the Delivery Output Detector 34 in order to for the UPS Management System to determine battery condition, reserve capacity, and load condition. It influences the UPS Management System 31 to re-engage the AC Power Source to supply electricity via On/Off Switch 317, and resets the UPS 32 back to normal operating mode and allows the Battery Charger 321 to charge the UPS batteries 322. It receives its direction from the Microprocessor 312.

The Delivery Output Detector 316 is the component that determines and digitizes various electricity-related measurements, including but not limited to voltage, current, power, frequency, impedance, and run-times at the Load 33. It is attached to the input-side of the Load 33 and does not effect the normal operation of the UPS 32 or Load 33.

The Aggregation Gateway 317 is the component that allows a plurality of local UPS Management Systems 31 to share one Network Connection 36, and provides local aggregation to off-load Wide Area Network 36 communications bottlenecks. It also provides harmonious interaction of all UPS Management Systems under its direction. It works together with each UPS Management System 31, Central Control 38, and the System Software 37. The gateway 317 is useful for a location that has a plurality of UMSs 31 each associated with a different UPS 32 and load 33.

The Central Control 38 is the central computational system connected through communication networks to a power company's dynamic data bases. It receives centrally operating conditions of power plants and other power generating stations on the grid. This central system is equipped with a complex array of trademarked software (AskOT, AEMPFAST, SUREFAST, etc.) available from Optimal Technologies International containing a degree of intelligence capable of optimizing power by making decisions using a very large base of real time data. It is capable of rapidly assessing power operating conditions of electric power generation facilities and their transmission counterparts. It also has the ability for rapid decision making and two-way communications through the Network Connection 36 to associated UPS Management Devices 31.

The System Software 37 comprises software, such as software available from Optimal Technologies International, that has the ability to monitor, assess, optimize, and rank complicated power consumption patterns and trends such that control information is provided to various UPS Management Devices so that they may take action to bring on line additional sources of electrical energy or other appropriate ancillary services. This system can be applied to any electricity service requiring load balance support from small buildings to the greater National Electric Grid thus forming a power industry wide system of protection. The software should work with quick response programs to control the remote power supplies in order to effectively reduce power used during peak demand times. This creates a more stable and efficient Grid by making fuller use of existing resources with improved demand response strategies and added critical control functions.

The Monitored Power Industry 39 is the effected domain of all power producers and operators falling within the monitoring and control functions of this embodiment.

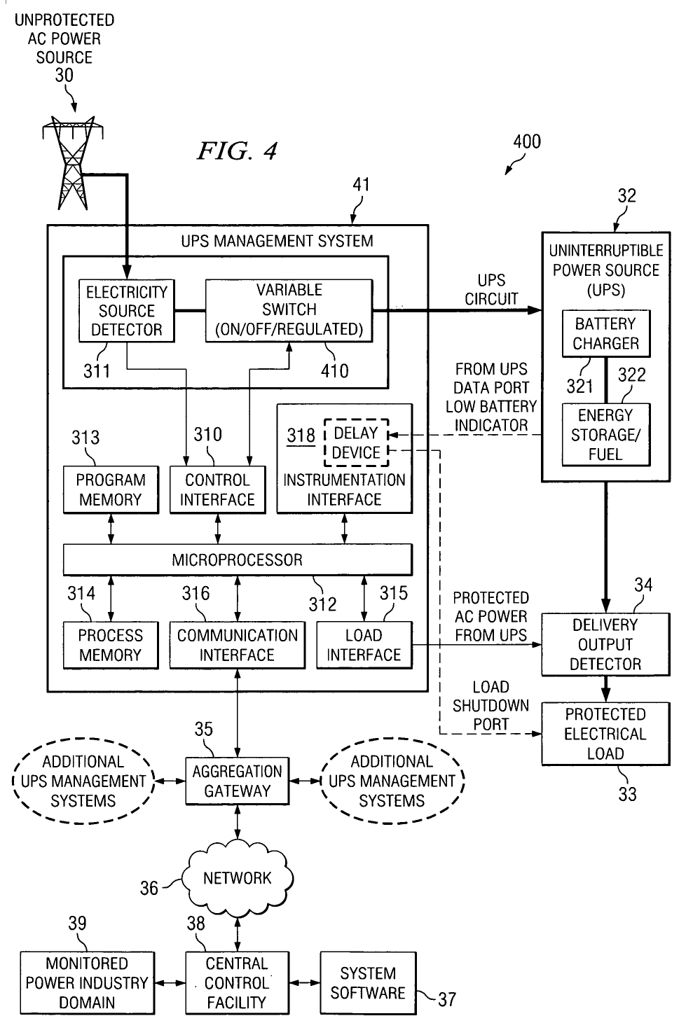

FIG. 4 depicts an arrangement 400 of another embodiment of the invention. This arrangement 400 is similar to the arrangement 300 of FIG. 3. Common elements have the same identifier.

In this embodiment, a Variable Switch 410 that can perform On, Off, and Regulated power output to the UPS is used instead of an on/off switch. Regulation can also be performed smoothly or via On/Off duration. For example, for an On/Off ratio of 3, the utility would see an average 25% drop in load for this location and the UPS Grid Offset would last 1.25 times longer.

Smooth regulated power output can be used to partition the amount of power being supplied from the AC Power Source 30 but is only possible for UPS systems that can continue to operate (e.g. charge their batteries) at lower power input. For example: an AC Power Source regulated to continuously supply 50% of UPS load means the UPS Batteries will provide the other 50% and will therefore last twice as long. The utility grid operator Regulation can therefore be used to sustain the Grid Offset to meet a desired time allotment—although at a reduced Offset amount. Note that this feature is useful because most Grid Offset contracts require time blocks of one hour or more, which few UPS systems can reliably provide at full load.

Regulated switching, performed dynamically, also enables the ability to provide Contingency Reserve and still meet contract time block commitments. For example, the end-user may wish to always have a minimum of 25% reserve capacity for emergencies. The actual Offset is reduced by 25% but continues to offer value.

FIG. 4 includes the Variable Switch 410, which is capable of causing the line power supporting an uninterruptible power supply unit to be turned off, on, or regulated at a partial setting. It is used in this embodiment to simulate a partial power interruption condition (0 to 100%) or to restore power as required. It causes an Uninterruptible Power Supply 32 to use partial UPS output (Reserve capacity or runtime) in support of its load. When failed, it automatically turns On full power to the UPS Circuit.

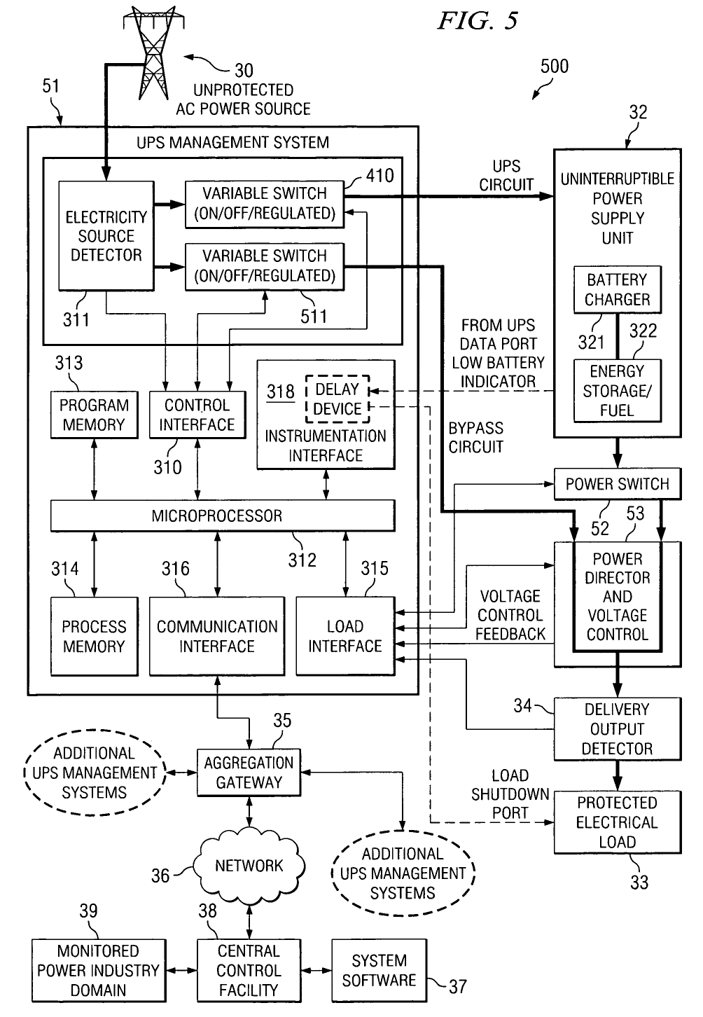

FIG. 5 depicts an arrangement 500 of another embodiment of the invention. This arrangement 500 is similar to the arrangement 300 and 400 of FIGS. 3 and 4. Common elements have the same identifier.

As shown in FIG. 5, this embodiment adds a parallel bypass subsystem to the arrangement of FIG. 4, which allows variable (regulated) AC Source Power to supply power to the load directly. The operation of this embodiment is useful in the event partial power from the UPS is required but the design of the UPS makes it difficult to feed partial AC Source power through the UPS.

The parallel bypass system of embodiment uses three additional components to those already described in FIG. 4. These components include Variable Switch 511, Power Switch 52 and Power Director 53, and allow regulated power to bypass the UPS Unit and supply the Load directly.

The operation of this embodiment allows On/Off or smooth regulated power to be supplied to any battery-type UPS and also allows On/Off or smooth regulated power to be supplied to any Load. Any combination of On/Off and Smooth Regulated power needed to supply Load and/or UPS requirements can be split between the Bypass Circuit and the UPS Circuit. As with the operation of the embodiment of FIG. 4, the operation of this embodiment can be used to partition the amount of power being supplied from the AC Power Source.

This embodiment includes a Power Switch 52 to completely isolate the UPS 32 from the Load 33. When the Power Switch 52 is used to isolate the Load from the UPS, the Variable Switch 510 can be switch on to charge the Batteries 322 to any desired level, including Contingency Reserve requirements as determined by the end-user.

The Variable Switch 511 begins a parallel UPS Bypass Circuit and is capable of causing the line power supporting a Load to be turned off, on, or smoothly Regulated at a partial setting. It performs similarly to Variable Switch 410. It is used in this embodiment to simulate a partial power interruption condition (0 to 100%) or to restore power as required. It causes an Uninterruptible Power Supply 32 to use none, all, or partial UPS output (Reserve capacity or runtime) in support of its load 33. When failed, it automatically shuts off power to the Bypass Circuit.

The Power Switch 52 causes the Load to be isolated from the UPS. It is used in this embodiment to ensure all AC Power entering the UPS is used for UPS and Battery Charger requirements only. No AC Source Power is supplied from the UPS system in this mode. When failed, it automatically closes the connection to the Load.

The Power Director 53 synchronizes for frequency differences and other critical power factors of power coming from the Bypass Circuit and the UPS system. It isolates and ensures no bypass supplied power or UPS supplied power can backfeed into either supply line. It ensures that the percentage of power supplied to the Load from the UPS and from the Bypass Circuit equals exactly 100% of the power demanded by the Load. It performs its functions dynamically, using a control feedback loop. When failed, it automatically directs all (100%) power from the UPS Circuit to the Load.

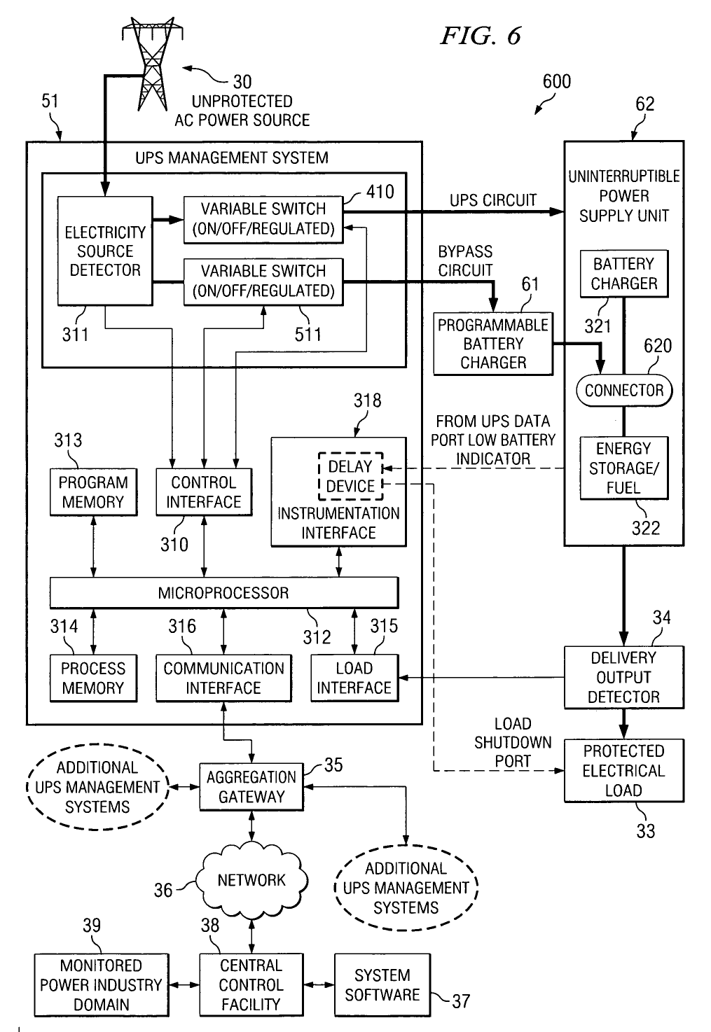

FIG. 6 depicts an arrangement 600 of another embodiment of the invention. This arrangement 600 is similar to the arrangement 300, 400, and 500 of FIGS. 3-5, respectively. Common elements have the same identifier.

As shown in FIG. 6, this embodiment includes the addition of a Programmable Battery Charger 61 to the arrangement 400 of FIG. 4 and uses Variable Switch 511 of the arrangement 500 of FIG. 5 through a UPS Battery Connector Adapter 620 to charge the UPS Battery 322 directly.

This embodiment is useful when the battery connector is accessible and the UPS design will not accommodate a partial AC Source Power and can only work with full or no AC Source Power, and/or when the UPS design will accommodate partial AC Source Power but the UPS Battery Charger 321 will not. In this embodiment the UPS Battery can be charged separately. Reserve Battery capacity is strengthened via this Mode without affecting the functionality of the UPS.

In FIG. 6, the Variable Switch 511 begins a parallel Bypass Circuit capable of supporting a Programmable Battery Charger. The Programmable Battery Charger can be supplied with no, full, or smoothly Regulated power. It performs similarly to Variable Switch 410. It is used in this embodiment to separately charge the UPS Batteries 322. When failed, it automatically shuts off power to the Bypass Circuit.

The Programmable Battery Charger 61 charges the UPS Battery separately. When failed, it automatically disconnects from the UPS Battery.

The UPS Battery Connector Adapter 620 provides access to UPS Batteries for separate charging purposes. When failed, it automatically disconnects from the UPS Battery.

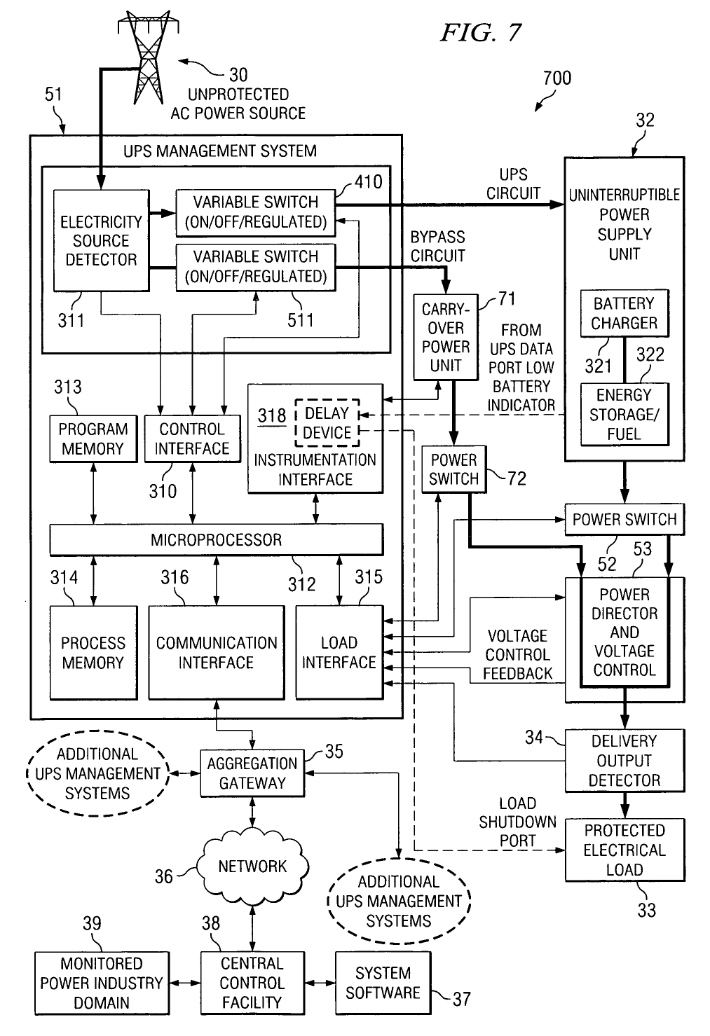

FIG. 7 depicts an arrangement 700 of another embodiment of the invention. This arrangement 700 is similar to the arrangement 300, 400, 500, and 600 of FIGS. 3-6, respectively. Common elements have the same identifier.

As shown in FIG. 7, this embodiment includes a Carry-Over Power Unit 71 and a Power Switch 52 to the Bypass Circuit of FIG. 5.

This embodiment includes the Carry-Over Power Unit 71, which is used to provide instantaneous bursts of AC power sufficient to supply 100% of the Load during the transition from any power supplied through the Bypass Circuit to UPS-supplied power. Burst power is typically supplied by a small battery or spinning flywheel and is only required to avoid any interruption to the Load during the switch from Bypass-supplied power to UPS-supplied power. It also guards against power quality problems on the Bypass Circuit as viewed from the Load 33. Power quality problems can include voltage surges, voltage spikes, voltage sags, and frequency deviation. Except for the short time required and therefore small power supply required to transfer full Load to the UPS, the Carry-Over Power Unit 71 can closely resemble a small UPS.

The Carry-Over Power Unit 71 is used prevent Load disruption when the Load is obtaining power through the Bypass Circuit and there is an AC Power Source interruption (blackout). Under these conditions, a transition from Bypass Circuit to UPS Circuit is critically important. Under these conditions the UPS may not be able to immediately transition to supply 100% protected power to support the Load. Transition periods can also vary depending on the type of UPS used. For example, battery-type UPSs may have transition periods measured in milliseconds while fuel-fired UPS systems may require up to 60 seconds to supply power to the Load.

The Power Switch 52 causes the Load to be isolated from the Carry-Over Power Unit. It is used in this invention to ensure the complete isolation of the Carry-Over Power Unit from the Load. It allows the Carry-Over Power unit to be quickly isolated for recharge purposes. No AC Source Power is supplied from the Carry-Over Power Unit in this mode. When failed, it automatically opens the connection to the Load.

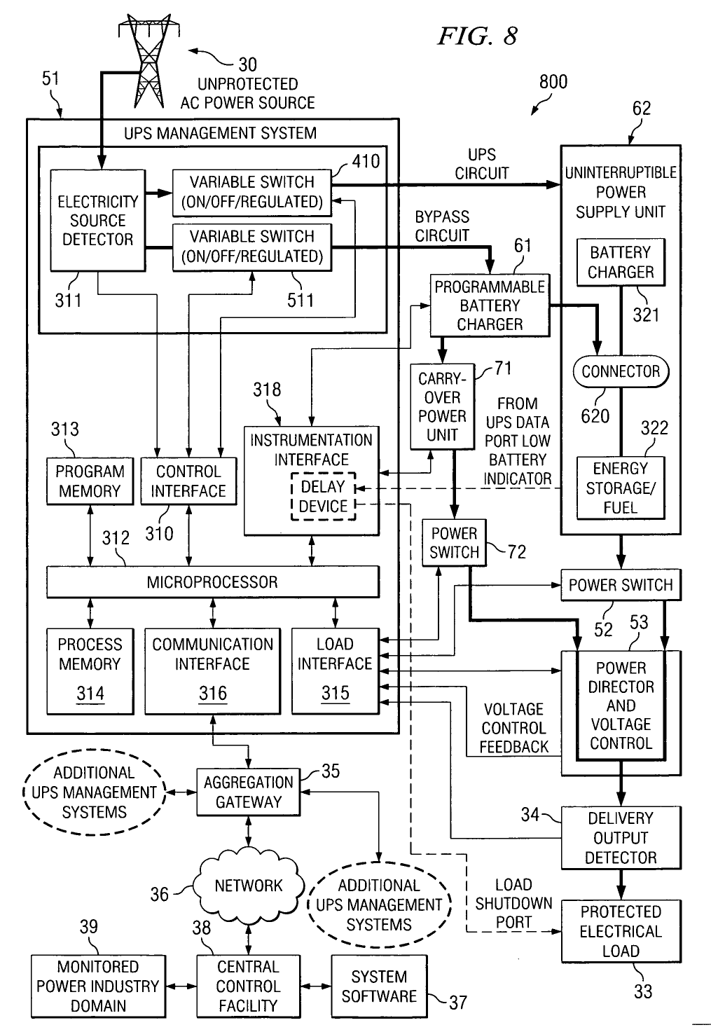

FIG. 8 depicts an arrangement 800 of another embodiment of the invention. This arrangement 800 is similar to the arrangement 300, 400, 500, 600, and 700 of FIGS. 3-7, respectively. Common elements have the same identifier.

As shown in FIG. 8, this embodiment encompasses all of the features of the arrangement 300, 400, 500, 600, and 700 of FIGS. 3-7, respectively.

This embodiment is a system of distributed electric service power supplies under the control of a central automated control system with the capability of real-time power supply load monitoring and control. This system is capable of assessing a broad range of operating conditions among a vast array of monitored power producing units such that the overall performance of the entire integrated power service system achieves 1) maximum reliability at 2) less cost using optimum load management as its major effecting parameter, and 3) provides end-user ability to choose how much Contingency Reserve to allocate for emergencies. The preferred embodiment of this invention is a subset of this system in which a demonstration of the above capability is achieved through monitoring and control of a specific set of power supplies normally used to insure continued service in the event of conventional central electric power service failures.

The embodiments of this invention allow it to achieve its objective of maximum load-leveling among multiple power supplies at least cost and still meet end-user requirements.

The process for this achievement includes a Central Control Facility 38 that is capable of network monitoring through the interface 316 and network 36 a large array of large and small power producing power supplies, the larger ones being capable of power production and transmission (e.g. the power industry) and the smaller ones being capable of energy storage 322. The Central Control Facility 38 should have high speed computation equipment (computers) and software for interactive monitoring, control, and network communications that able to assess the overall condition of the Monitored Power Industry Domain 39 for its real-time operating performance in meeting demand and appropriate Ancillary Service requirements relative to its on-line generation and stand-by capacity. The performance of the power transmission system is included and addressed in this system.

For purposes of illustration one UPS Management Device 31, 41, 51 with its connection to one remote power supply 32, 62 is shown in each of FIGS. 2A-2C, and 3-8. As a system it may utilize one or more of these remote power supplies with the respective indicated controls. Within the UPS Management Device 31, 41, 51, there is a functional Instrumentation Interface 318, which is capable of interpreting both analog and digital information to and from the Uninterruptible Power Supply Unit's 32 Energy Storage 322 as required for the purpose of determining the state of preparedness of that storage whether it be the a storage battery or the fuel supply for an engine-generator set or any like generic storage-to-electricity conversion device including flywheel, capacitor, or other form of rechargeable battery as can be found in any commercially available stationary (e.g., for computer and equipment backup) or mobile (electric or hybrid vehicles that can be attached to the utility power system) uninterruptible power supply.

The Instrumentation Interface 318 is also capable of measuring power consumption as required for billing through multi-channel connections as required. Its primary purpose in this embodiment being to monitor the volume equivalent of storage availability before and after actions are taken to use said Energy Storage 322 to displace any anticipated or detected demand peak derived from the Central Control Facility 38 through the communication link using the Network Connection 36. The Instrumentation Interface 318 works also to manage Load shutdown commands, manage the Carry-Over Power Unit 71, manage the Programmable Battery Charger 61, and work together with appropriate information from the Control Interface 310, and the Load Interface 315.

The UPS Management Device 31, 41, 51 functions to control this storage to come on-line by simulating a power failure condition with a signal from the Microprocessor 312 through the Control Interface 310 causing power to be interrupted or reduced by On/Off Switch 317 or Variable Switch 410 to the Uninterruptible Power Supply Unit 32. Said Uninterruptible Power Supply Unit 32 causing said Energy Storage 322 to be used to supply power to the Protected Electrical Load 33. Said Energy Storage 322 being utilized to provide alternate electric power from a Energy Storage device such as a Battery through an inverter or from a fuel supply to an engine-generator or any like process that converts stored energy into electric service energy.

The Central Control Facility 38 and the UPS Management Device 31, 41, 51 work together with a division of functions where software 37 is primarily fast analysis of large data bases and the output of instructions while device 31, 41, 51 is used for instrumentation and control. The UPS Management Device 31, 41, 51 will only take action to cause the storage to come on line if according to its local Instrumentation Interface 318, and/or the Control Interface 310 with meter data from Electricity Source Detector 311, and/or the Load Interface 315 with meter data from the Delivery Output Detector 34, the Energy Storage Runtime has the integrity and capacity to meet the requirements of incremental contribution to Grid load displacement (Grid Offset) and still meet its user-determined Contingency Reserve requirements. Such information is made available to the Central Control Facility 38 so that it may recalculate alternative options in the event of deficit storage in the network. The Microprocessor 312 does the local computational interpretational state of readiness using local instructions from the Program Memory 313. The Process Memory 314 is an essential component of 312 by providing dynamic data exchange.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

The processor may be any general purpose CPU, such as an Intel Pentium processor. However, the present invention is not restricted by the architecture of processor as long as the processor supports the inventive operations as described herein. The program memory and/or process may be random access memory (RAM), such as SRAM, DRAM, or SDRAM, or may be read-only memory (ROM), such as PROM, EPROM, or EEPROM, as needed. The network may be one or more of a telephone network, a local (LAN) and/or a wide-area (WAN) network, an Ethernet network, and/or the Internet network.

Embodiments of the invention may be used to control a house, a neighborhood, a building, a collection of buildings, a portion of a city, a portion of a state, a portion of a country, a portion of a continent. For example, a house may have a plurality of PMS systems, one for each computer, one for each major appliance, and the aggregation gateway 35 would manage all of the PMS systems for the house. This example may be scaled up for larger control domains.

The various components of the different embodiments of the invention by located in one box, or may be located in more that one box. The boxes may be located close together, e.g. a common location or building, or the boxes may be remote from each other and connected via a network.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electric power management system for managing a load comprising:
a connection to a power supply network;
a connection to a back-up power supply, wherein the back-up power supply is connected between the power supply network and the load; and
a controller that causes the load to receive power from the power supply network that is reduced by an amount, and causes the back-up power supply provides the amount of power to the load.

2. The system of claim 1, wherein the controller operates to cause the load to receive power from the power supply network that is reduced by an amount during a peak period of power consumption on the power supply network.

3. The system of claim 1, further comprising:
a communication network that connects the power supply network and the back-up power supply to the controller.

4. The system of claim 3, wherein the communication network is the Internet.

5. The system of claim 3, wherein the communication network is the power supply network.

6. The system of claim 3, wherein the communications network is the building wiring.

7. The system of claim 3, wherein the communication network is a wide area network.

8. The system of claim 3, wherein the communication network is proprietary network.

9. The system in claim 3, wherein the communication network comprises:
at least one terrestrial wireless transceiver link.

10. The system in claim 3, wherein the communication network comprises:
at least one non-terrestrial satellite link.

11. The system of claim 1, wherein the back-up power supply is one of:
a rechargeable storage battery, a liquid or gas fueled reciprocating engine-electric generator unit, a liquid or gas fueled turbine engine-electric generator unit, a fuel cell, a flow battery, a flywheel, and other refillable energy storage device.

12. The system of claim 1, wherein the controller operates according to one of:
a human operator; an automated, non-human operator; and a combination of a human and non-human operator.

13. The system of claim 1, wherein the load is one of:
a computer system, a lighting system, an electronic device, and an electrical load of a building.

14. The system of claim 1, further comprising:
an instrumentation interface that monitors the load and the power supply network.

15. The system of claim 13, wherein the instrumentation interface is also used for energy service billing.

16. The system of claim 13, wherein the instrumentation interface is used to determine the condition and capacity of the backup power supply source.

17. The system of claim 1, wherein the controller is operative to cause the back-up power supply to provide the amount of power to the load until a minimum amount of power remains in the back-up power supply, whereby the controller then causes the load to receive power from only from the power supply network.

18. The system of claim 15, wherein an end-user of the back-up power supply determines the minimum amount.

19. The system of claim 1, further comprising:
means for determining the maximum load of the load;
means for determining the minimum load of the load; and
means for correlating the load with an output of the back-up power supply to determine a non steady-state run time of the back-up power supply.

20. The system of claim 1, further comprising:
an override switch for overriding the controller and returning the load to receiving all power from the power supply network.

21. The system of claim 21, further comprising:
means for tracking usage of the override switch.

22. The system of claim 21, wherein the controller is one of a plurality of controllers, with each controller associated with one of a plurality of loads, with one of a plurality of back-up power supplies, and with one of a plurality of power supply networks.

23. The system of claim 22, further comprising:
means for aggregating the quantity of electrical power available within a portion of the plurality of back-up power supplies.

24. The system of claim 22, further comprising:
means for aggregating an available time in which a portion of the plurality of back-up power supplies can serve their associated loads.

25. The system of claim 1, further comprising:
means for determining a quality of power of the power supply network.

26. The system of claim 25, wherein the means tracks one or more of a plurality of power conditions comprising:
sags, blips, voltage problems, frequency problems, and waveform problems.
